(19) United States
(12) Patent Application Publication
(10) Pub. No.: US 2017/0214260 A1
(43) Pub. Date: Jul. 27, 2017

(54) SET FOR HOLDING AND CHARGING MOBILE DEVICE

(71) Applicant: IGC CO., LTD., GUMI-SI (KR)

(72) Inventor: Ingyu KIM, Gumi-si (KR)

(21) Appl. No.: 15/314,943

(22) PCT Filed: Nov. 21, 2014
(86) PCT No.: PCT/KR2014/011289

§ 371 Date: Nov. 30, 2016

(30) Foreign Application Priority Data
Aug. 8, 2014 (KR) 10-2014-0102292

(51) Int. Cl. H02J 7/00; H02J 7/02

(52) U.S. Cl. CPC H02J 7/0044; H02J 7/025

(57) ABSTRACT

There is provided a set for holding and charging a mobile device, the set comprising: an assembly for holding and charging a mobile device; and attachments attached to the mobile device, wherein the assembly includes: a holding and charging sub-assembly; and a support to support the sub-assembly, wherein the holding and charging sub-assembly includes: a sub-assembly body; a charging unit received in the body, wherein the charging unit has a primary coil; and a magnetic holder to magnetically hold the mobile device, wherein the attachments attached to the mobile device comprises: a magnetic attachment to be detachably attached to the magnetic holder; and a charging receiver having a secondary coil embedded therein.

### BACKGROUND

Field of the Present Disclosure

The present disclosure relates to a set for holding and charging a mobile device, and, more particularly, to a set for holding and charging a mobile device having an assembly for holding and charging the mobile device, and an attachment attached to the mobile device, wherein the assembly has a magnetic holder and the attachment include a magnetic attachment magnetically coupled to the magnetic holder. Discussion of Related Art

In a wired charging method of the mobile device using the charging cable, there is a problem that the charging cable terminal is inserted and removed each time the charging cable terminal was used. This repetition may lead to the charging cable terminal failure.

In recent years, mobile devices have been commercialized due to the increased number of IT technologies using wireless networks instead of the wired networks for user's mobility and convenience.

Currently, a wireless charging method is used to induce current flow through electromagnetic induction. In this connection, since the electric power transmission distance is short, a distance difference of several mm may cause charging efficiency to drop significantly. Thus, it is important to keep the mobile device at the correct position on the wireless charger.

As shown in FIG. 1, in general, (a) a mobile device having a charging receiving pad is disposed on a plate-shaped charger, or (b) a coupling bracket is used to secure the mobile device to a vehicle or a holder.

These methods have a disadvantage in that, although the user is informed of an indication whether the positions of the mobile device and the charging unit match, this indication may not mean that the positions of the mobile device and the charging unit match are accurately matched.

In addition, there is a problem that the user attaches forcedly fixes the mobile device by opening the coupling bracket, thereby causing inconvenience in attachment and detachment.

Korean Patent Publication No. 10-2014-0051569 titled as “wireless charging pad for mobile terminal” includes a touch screen formed on a housing, a power transmitting module for transmitting a wireless power signal, a storage unit for storing one or more applications, and a controller. There is a problem that there is an inconvenience in attachment and detachment.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

The present disclosure is to provide a set for holding and charging a mobile device wherein the mobile device may be correctly positioned on the wireless charging device in one-touch manner.

In one aspect of the present disclosure, there is provided a set for holding and charging a mobile device, the set comprising: an assembly for holding and charging a mobile device; and attachments attached to the mobile device.

In one implementation, the assembly includes: a holding and charging sub-assembly; and a support to support the sub-assembly

In one implementation, the holding and charging sub-assembly includes: a sub-assembly body; a charging unit received in the body, wherein the charging unit has a primary coil; and a magnetic holder to magnetically hold the mobile device.

In one implementation, the attachments attached to the mobile device comprises: a magnetic attachment to be detachably attached to the magnetic holder; and a charging receiver having a secondary coil embedded therein, wherein induction occurs between the primary and secondary coils, wherein the charging receiver has a first terminal to be electrically connected to a second terminal in the mobile device.

In one implementation, the support includes: an L shaped support body having a vertical portion tilted backwardly at a predetermined angle; a bottom attachment coupled to the support body at the bottom thereof; a charging cable holder to hold a charging cable, wherein the cable holder is coupled to the support body at the rear portion thereof; and a ball head coupled to the support body at the front portion thereof, wherein the ball head allows pivotal movement of the holding and charging sub-assembly, wherein the ball head is pivotally coupled to the sub-assembly body.

In one implementation, the bottom attachment is formed of a box or cylindrical structure to be detachably attached to a dashboard or front glass of a vehicle, or wherein the bottom attachment is formed of a plate to be removably fitted into a cassette tape or CD insertion gap.

In one implementation, the bottom attachment is formed of a box or cylindrical structure, wherein the bottom attachment includes: a central shaft to support the support body; a coil spring surrounding the central shaft; a suction plate made of a rubber or synthetic resin and coupled to the central shaft; and a protrusion extending from the suction plate.

In one implementation, the support includes: a hinged lever coupled to the coil spring at a distal upper end thereof, wherein the hinged lever is hingedly moved, and the hinged lever is hingedly coupled to the support body; and a depression defined in the support body to receive the hinged lever, wherein the downward movement of the hinged lever allows attachment of the suction plate to a target surface.

In one implementation, the holding and charging sub-assembly further includes: a cover to cover the charging unit; an anti-slippery pad made of a rubber or synthetic resin and disposed on the cover; and an annular frame to connect the sub-assembly body and cover, wherein the magnetic holder is disposed between the charging unit and the cover, wherein the body 202 is pivotally coupled to the support via a ball head.

In one implementation, the magnetic holder includes: a predetermined number of first magnets spacedly arranged in a predetermined interval; and a plurality of second magnets, each adjacent to each of the first magnets, wherein each of the first magnets has a greater physical size and magnetic magnitude that those of each of the second magnets, wherein each of the first magnets has a different polarity than that of each of the second magnets.

In one implementation, the charging unit includes: the primary coil; a PCB board configured to suppress leak and transient currents; an connection line to allow electrical connection between the PCB board and primary coil; and an insulator disposed between the PCB board and primary coil to electrically insulate between the PCB board and primary coil.

In one implementation, the magnetic attachment includes: an attachment film to be attached to the mobile device; holes defined therein at predetermined positions of the film; thin-filmed magnets received in the holes respectively, wherein each of the thin-filmed magnets has a different polarity than that of each of the first magnets; and a contact pad formed on the attachment film.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a perspective view of a set for charging a mobile device in a conventional approach.

FIG. 2 is a side exploded view of a set for holding and charging a mobile device in accordance with one embodiment.

FIG. 3 is a rear exploded view of an assembly for holding and charging a mobile device.

FIG. 4 is a side view of an assembly for holding and charging a mobile device.

FIG. 5 is a perspective view of the support to support the holding and charging sub-assembly in accordance with one embodiment.

FIG. 6 is a top view of a magnetic holder in the holding and charging sub-assembly in accordance with one embodiment.

FIG. 7 is an exploded view of a magnetic attachment for a mobile device in the set for holding and charging the mobile device in accordance with one embodiment.

FIG. 8 is a perspective view of a set for holding and charging a mobile device in accordance with one embodiment.

FIG. 9 is a top view of a charging receiver disposed in the mobile device in accordance with one embodiment.

### REFERENCE NUMERALS

10 charging unit

100: primary coil

101: insulator

102: PCB board

103: connection line

20: holding and charging sub-assembly

200: magnetic holder

200a: big-sized and strong-magnetic magnet

200b: small-sized and weak-magnetic magnet

201: cover

202: body

203: annular frame

204: further charging module

205: hollow cylindrical coupler

206: hollow cylindrical cover

207: anti-slippery pad

30: support

300: support body

301: bottom attachment

301a: central shaft

301b: coil spring

301c: hinged lever

301d: suction plate

301e: protrusion

301f: depression

302: charging cable holder

303: ball head

40: magnet attachment

400: attachment film

400a: magnet hole

401: thin-filmed magnet

402: contact pad

50: charging receiver

50a: secondary coil

50b: male terminal

60: female terminal

### DETAILED DESCRIPTIONS

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

Hereinafter, a set for holding and charging a mobile device in accordance with the present disclosure will be descried below in details with reference to the accompanying drawings.

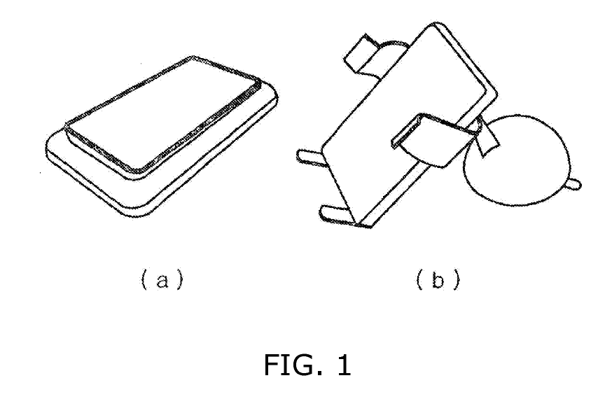

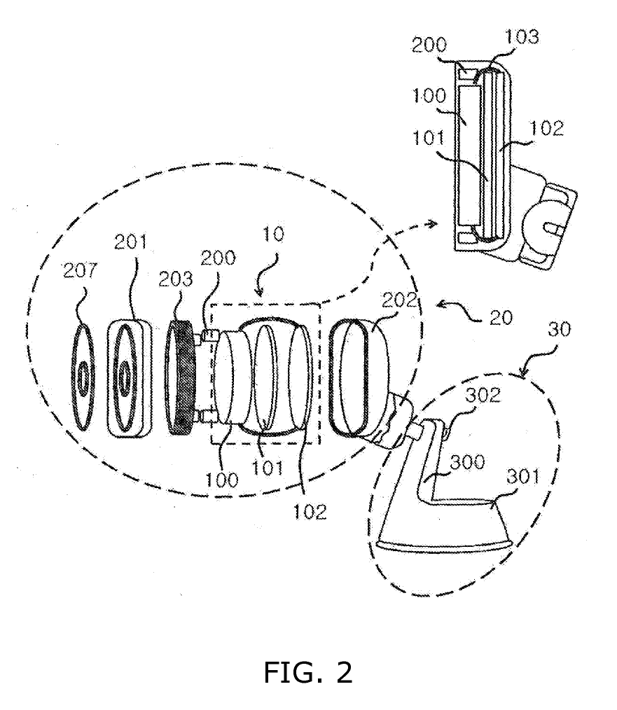

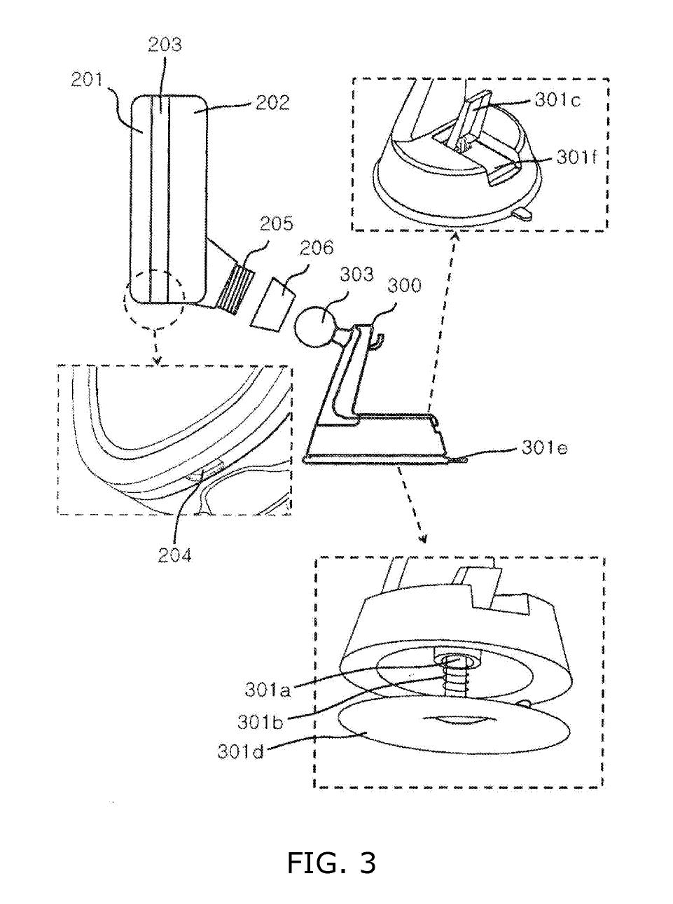

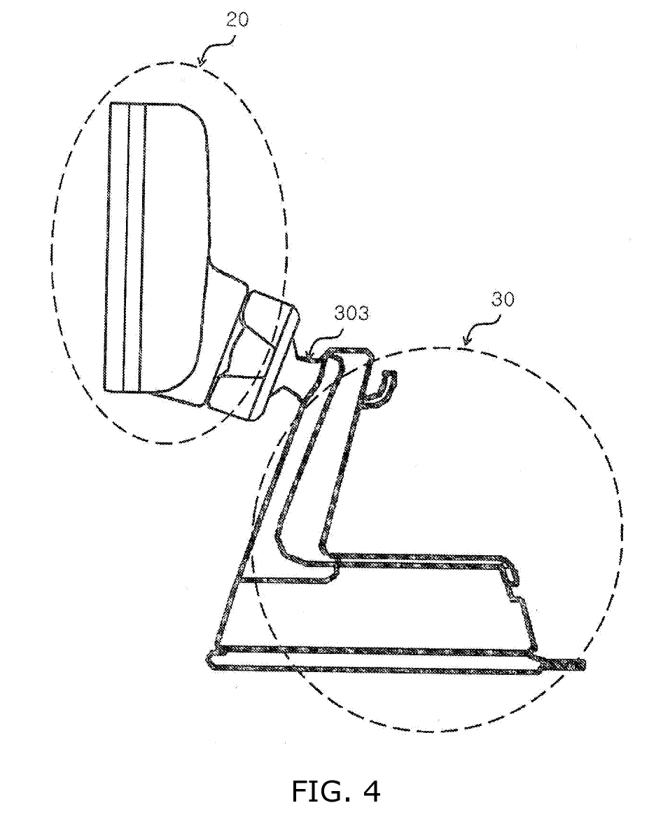

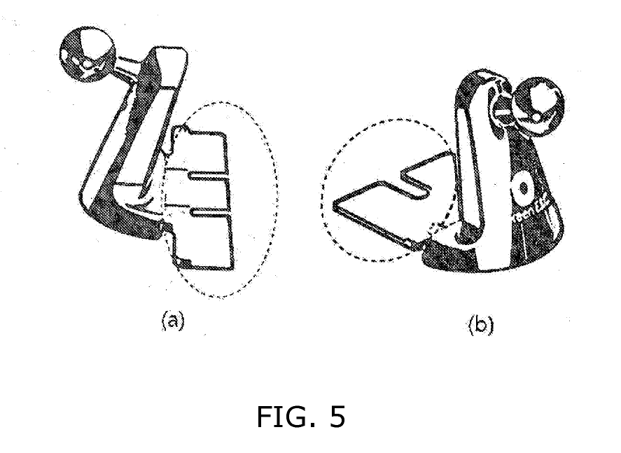

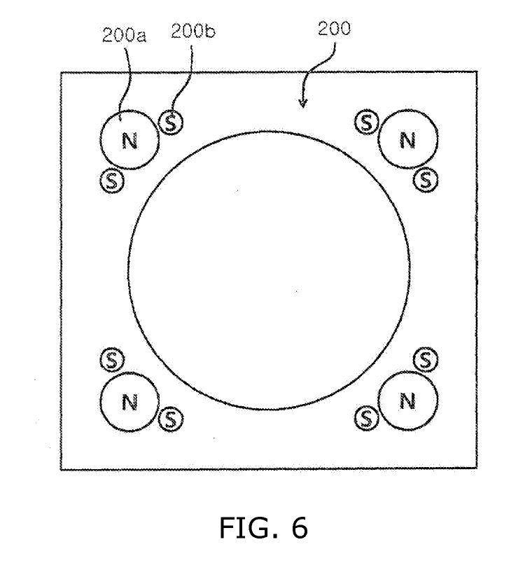

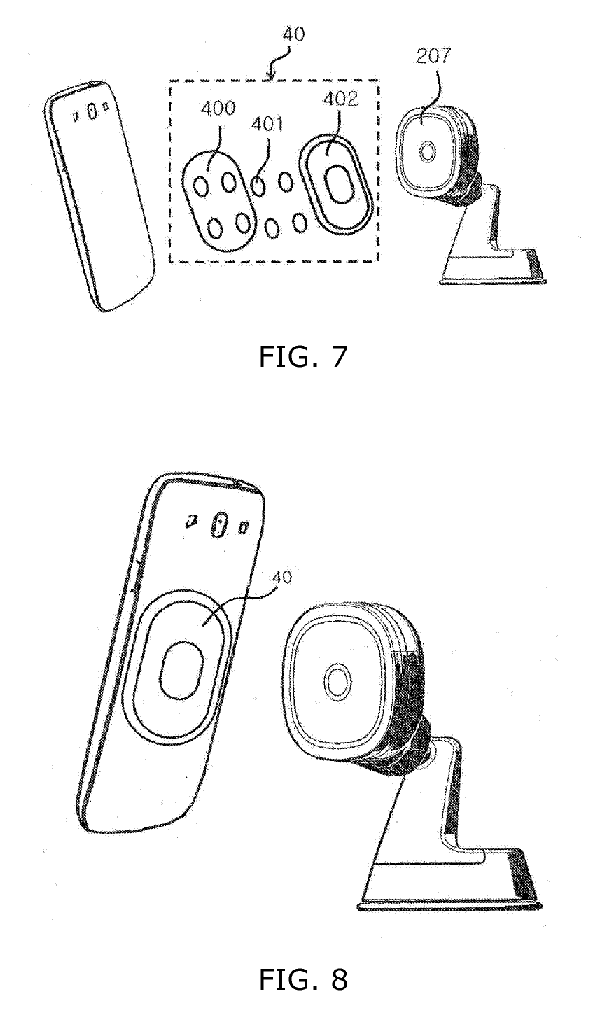

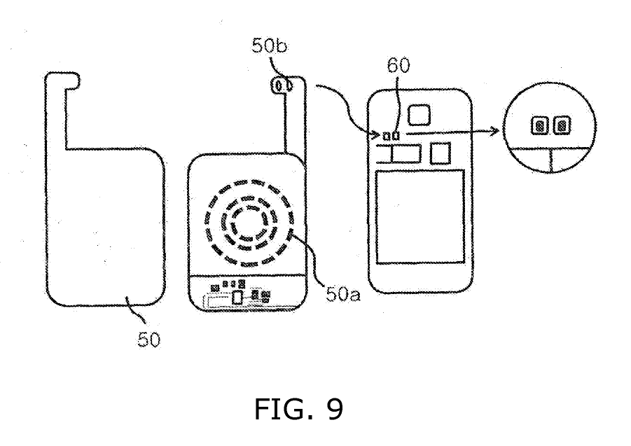

FIG. 1 is a perspective view of a set for charging a mobile device in a conventional approach. FIG. 2 is a side exploded view of a set for holding and charging a mobile device in accordance with one embodiment. FIG. 3 is a rear exploded view of an assembly for holding and charging a mobile device. FIG. 4 is a side view of an assembly for holding and charging a mobile device. FIG. 5 is a perspective view of the support to support the holding and charging sub-assembly in accordance with one embodiment. FIG. 6 is a top view of a magnetic holder in the holding and charging sub-assembly in accordance with one embodiment. FIG. 7 is an exploded view of a magnetic attachment for a mobile device in the set for holding and charging the mobile device in accordance with one embodiment. FIG. 8 is a perspective view of a set for holding and charging a mobile device in accordance with one embodiment. FIG. 9 is a top view of a charging receiver disposed in the mobile device in accordance with one embodiment.

FIG. 2 is a side exploded view of a set for holding and charging a mobile device in accordance with one embodiment. The set for holding and charging a mobile device in accordance with one embodiment may include an assembly for holding and charging a mobile device and an attachment for the mobile device. The assembly for holding and charging a mobile device may include a holding and charging sub-assembly 20 and a support 30. The holding and charging sub-assembly 20 may include a body 202, a charging unit 10 received in the body 202, and a magnetic holder 200 to magnetically hold the mobile device.

The charging unit 10 may include a primary coil 100. The charging unit 10 may act to receive an external power from a further charging module 204 as described below with reference to the primary coil 100.

The charging unit 10 may further include a PCB board 102 connected to the further charging module 204. The PCB board may include a transistor, resistor, etc. to suppress leak and transient currents.

The PCB board 102 and primary coil 100 may be electrically connected to each other via a connection line 103. An insulator 101 may electrically insulate between the PCB board 102 and primary coil 100.

The charging receiver 50 as described below with reference to FIG. 9 may include a secondary coil 50a. Thus, between the primary and secondary coils 100 and 50a, an induction may occur, to generate an induction current in the secondary coil 50a which in turn may be supplied to the mobile device power supply.

The charging receiver 50 may have a male terminal 50b connected to a female terminal 60 of the mobile device.

More specifically, the charging unit 10 may magnetically interact with the charging receiver 50 as described below with reference to FIG. 9, wherein the charging receiver 50 may be coupled to the mobile device at a rear portion thereof.

Further, the charging unit 10 may have an output current of 1A. The charging unit 10 may be lightweight and thinner.

The holding and charging sub-assembly 20 may include the body 202 receiving the charging unit 10, a cover 201 to cover the charging unit 10, and an anti-slippery pad 207. The anti-slippery pad 207 may be made of a rubber or synthetic resin. The magnetic holder 200 may be disposed between the charging unit 10 and the cover 201. The body 202 may be pivotally coupled to the support 300 via a ball head 303 as shown in FIG. 3. The body 202 and cover 201 may be coupled to each other via an annular frame 203.

The annular frame 203 may have a specific color or material to impose a specific appearance.

The support 30 may include an L shape body 300 having a vertical portion tilted backwardly at a predetermined angle to allow easy pivotal movement. The support may further include a bottom attachment 301 coupled to the body 300 at the bottom thereof. The support may further include a charging cable holder 302 to hold a charging cable. The holder 302 may be coupled to the body 300 at the rear portion thereof.

Moreover, the support 30 may further include the ball head 303 coupled to the body 300 at the front portion thereof. The ball head 303 may allow the pivotal movement of the holding and charging sub-assembly 20. The ball head 303 may be coupled to the body 202 of the holding and charging sub-assembly 20.

The bottom attachment 301 may be detachably attached to a dashboard or front glass of the vehicle. In an alternative, the bottom attachment 301 may be removably fitted into a gap formed in the ventilation plates or CD insertion gap.

FIG. 3 is a rear exploded view of an assembly for holding and charging a mobile device. The body 202 may have a further charging module 204 embedded therein to be connected to a cigar jack via a charging cable or to a USB charger. The body 202 may have a hollow cylindrical coupler 205 coupled the body 202 at the rear portion thereof. A hollow cylindrical cover 206 may be coupled to the hollow cylindrical coupler 205.

The hollow cylindrical coupler 205 may be screw-coupled to the hollow cylindrical cover 206. For this, as shown in FIG. 3, the hollow cylindrical coupler 205 may have outer threads defined thereon, and the hollow cylindrical cover 206 may have inner threads defined thereon. The ball head

303 may be fitted into the hollow cylindrical cover 206 to pivotally move relative to the body 202.

The bottom attachment 301 may be of a rectangular or circular shape. The bottom attachment may have a central shaft 301a to support the support body 300 and a coil spring 301b surrounding the central shaft.

Moreover, the bottom attachment may have a suction plate 301d made of a rubber or synthetic resin to be coupled to the central shaft 301a. The suction plate 301d may have a protrusion 301e to allow easy detachment of the plate.

Moreover, the support 30 may have a hinged lever 301c coupled to the coil spring 301b at a distal upper end thereof. The hinged lever 301c may be hingedly moved. The hinged lever may be hingedly coupled to the support body 300. The support body may have a depression 301f defined therein to receive the hinged lever. When the hinged lever hingedly moves down, the hinged lever may fit into the depression 301f.

When the hinged lever hingedly moves down, the coil spring may be pulled up. This may pull up the central shaft 301a and the suction plate 301d coupled thereto to allow attachment of the suction plate to the target surface.

When the hinged lever hingedly moves up, an air may leak out of a space between the suction plate and the target surface. This may allow detachment of the suction plate from the target surface. Using the protrusion 301e, the suction plate may be detached.

FIG. 4 is a side view of an assembly for holding and charging a mobile device. The support 30 may include the L shape body 300 having the vertical portion tilted backwardly at a predetermined angle to allow easy pivotal movement. The ball head 303 to allow the pivotal movement of the holding and charging sub-assembly 20 may be made of a rigid plastic material such as ABS.

FIG. 5 is a perspective view of the support to support the holding and charging sub-assembly in accordance with one embodiment. The bottom attachment may be removably fitted into a gap formed in the ventilation plates or CD insertion gap. A left embodiment of FIG. 5 may be removably fitted into a box type tape insertion gap. A right embodiment of FIG. 5 may be removably fitted into the CD insertion gap.

In the right embodiment of FIG. 5, the bottom attachment may have a middle space defined therein. When the bottom attachment is removably fitted into the CD insertion gap, the middle space may be fitted with a CD holding protrusion.

If necessary, the bottom attachment 301 having a rectangular or circular shape may be replaced with those as shown in FIG. 5 depending on installation environments.

FIG. 6 is a top view of a magnetic holder in the holding and charging sub-assembly in accordance with one embodiment. The magnetic holder 200 may have a predetermined number of N polar big-sized and strong-magnetic magnets 200a spacedly arranged in a predetermined interval. The magnetic holder 200 may have S polar small-sized and weak-magnetic magnets 200b adjacent to each of the N polar big-sized and strong-magnetic magnets 200a.

In this way, between each S polar thin-filmed magnet 401 of a magnetic attachment 40 as described below with reference to FIG. 7 and each of the N polar big-sized and strong-magnetic magnets 200a, an attraction force may occur. Between each S polar small-sized and weak-magnetic magnet 200b and each S polar thin-filmed magnet 401 of a magnetic attachment 40 as described below with reference to FIG. 7, a weak repulsion force may occur. The weak repulsion force may allow accurate positioning between the holder 200 and the magnetic attachment 40.

The polarity setting between the holder 200 and the magnetic attachment 40 may be only an example. A number of the magnets may be only an example. Thus, the present disclosure is not limited to the above example.

FIG. 7 is an exploded view of a magnetic attachment for a mobile device in the set for holding and charging the mobile device in accordance with one embodiment. The magnetic attachment 40 may have an attachment film 400 to be attached to the mobile device.

Moreover, the attachment film 400 may detachably be attached to the mobile device at a rear face thereof. The attachment film 400 may be attached to the mobile device using an acrylic tape due to its good water-proof, heat-resistance, and bonding strength, etc.

Thus, when not charging the mobile device, the attachment film 400 may be detached from the mobile device at a rear face thereof. This may suppress the deterioration of charging efficiency.

The attachment film 400 may have holes 400a defined therein at predetermined positions thereof. Each thin-filmed magnet 401 may be received in each of the holes 400a. This may allow accurate positioning of the thin-filmed magnets 401, and a surface smoothness of the magnetic attachment.

In order to minimize a thickness of the magnetic attachment, the thin-filmed magnet 401 may have a thickness of 1 mm or less. The magnetic attachment 40 may be positioned relative to the magnetic holder 200 during attachment therebetween.

Moreover, the magnetic attachment 40 may have a contact pad 402 to be attached to the anti-slippery pad 207.

Each of the contact pad 402 and anti-slippery pad 207 may be made of a synthetic resin or rubber. This may ensure reliable attachment between the contact pad 402 and anti-slippery pad 207.

Moreover, each of the contact pad 402 and anti-slippery pad 207 may have a specific color. This may impose a specific design and appearance thereof.

Thus, the magnetic attachment 40 may be formed of a combination of the attachment film 400, the thin-filmed magnets 401 and the contact pad 402.

In another embodiment, the magnetic attachment may be disposed not out of the mobile device but therein. In this connection, a thin-filmed guide sticker may be attached onto the outer face of the mobile device to indicate a position of the magnetic attachment.

FIG. 8 is a perspective view of a set for holding and charging a mobile device in accordance with one embodiment. The magnetic attachment 40 on the rear face of the mobile device may be magnetically coupled to the holding and charging sub-assembly 20.

FIG. 9 is a top view of a charging receiver disposed in the mobile device in accordance with one embodiment. The charging receiver 50 may have the secondary coil 50a embedded therein. The charging receiver 50 may have the male terminal 50b electrically coupled to the female terminal 60 of the mobile device. Thus, the induction current from the secondary coil 50a may flow via the male terminal 50b to the female terminal 60.

What is claimed is:

1. A set for holding and charging a mobile device, the set comprising:
an assembly for holding and charging a mobile device; and
attachments attached to the mobile device,
wherein the assembly includes:
a holding and charging sub-assembly; and
a support to support the sub-assembly,
wherein the holding and charging sub-assembly includes:
a sub-assembly body;
a charging unit received in the body, wherein the charging unit has a primary coil; and
a magnetic holder to magnetically hold the mobile device,
wherein the attachments attached to the mobile device comprises:
a magnetic attachment to be detachably attached to the magnetic holder; and
a charging receiver having a secondary coil embedded therein, wherein induction occurs between the primary and secondary coils, wherein the charging receiver has a first terminal to be electrically connected to a second terminal in the mobile device.

2. The set of claim 1, wherein the support includes:
an L shaped support body having a vertical portion tilted backwardly at a predetermined angle;
a bottom attachment coupled to the support body at the bottom thereof;
a charging cable holder to hold a charging cable, wherein the cable holder is coupled to the support body at the rear portion thereof; and
a ball head coupled to the support body at the front portion thereof,
wherein the ball head allows pivotal movement of the holding and charging sub-assembly, wherein the ball head is pivotally coupled to the sub-assembly body.

3. The set of claim 2, wherein the bottom attachment is formed of a box or cylindrical structure to be detachably attached to a dashboard or front glass of a vehicle, or wherein the bottom attachment is formed of a plate to be removably fitted into a cassette tape or CD insertion gap.

4. The set of claim 3, wherein the bottom attachment is formed of a box or cylindrical structure, wherein the bottom attachment includes:
a central shaft to support the support body;
a coil spring surrounding the central shaft;
a suction plate made of a rubber or synthetic resin and coupled to the central shaft; and
a protrusion extending from the suction plate,
wherein the support includes:
a hinged lever coupled to the coil spring at a distal upper end thereof,
wherein the hinged lever is hingedly moved, and the hinged lever is hingedly coupled to the support body; and
a depression defined in the support body to receive the hinged lever,
wherein the downward movement of the hinged lever allows attachment of the suction plate to a target surface.

5. The set of claim 1, wherein the holding and charging sub-assembly further includes:
a cover to cover the charging unit;
an anti-slippery pad made of a rubber or synthetic resin and disposed on the cover; and
an annular frame to connect the sub-assembly body and cover,
wherein the magnetic holder is disposed between the charging unit and the cover,
wherein the body 202 is pivotally coupled to the support via a ball head.

6. The set of claim 1, wherein the magnetic holder includes:
a predetermined number of first magnets spacedly arranged in a predetermined interval; and
a plurality of second magnets, each adjacent to each of the first magnets,
wherein each of the first magnets has a greater physical size and magnetic magnitude that those of each of the second magnets,
wherein each of the first magnets has a different polarity than that of each of the second magnets.

7. The set of claim 1, wherein the charging unit includes:
the primary coil;
a PCB board configured to suppress leak and transient currents;
an connection line to allow electrical connection between the PCB board and primary coil; and
an insulator disposed between the PCB board and primary coil to electrically insulate between the PCB board and primary coil.

8. The set of claim 1, wherein the magnetic attachment includes:
an attachment film to be attached to the mobile device;
holes defined therein at predetermined positions of the film;
thin-filmed magnets received in the holes respectively, wherein each of the thin-filmed magnets has a different polarity than that of each of the first magnets; and
a contact pad formed on the attachment film.
